(19) United States
(12) Patent Application Publication
(10) Pub. No.: US 2019/0044616 A1
(43) Pub. Date: Feb. 7, 2019

(54) TECHNIQUES FOR RESOLVING ANGLE OF TRANSMITTER AND ANGLE OF RECEIVER IN LIGHT-BASED COMMUNICATION USED TO DETERMINE VEHICLE POSITION

(71) Applicants: Joseph Laski, Stoneham, MA (US); Richard Speer, Concord, MA (US)

(72) Inventors: Joseph Laski, Stoneham, MA (US); Richard Speer, Concord, MA (US)

(73) Assignee: OSRAM SYLVANIA Inc., Wilmington, MA (US)

(21) Appl. No.: 15/670,609

(22) Filed: Aug. 7, 2017

(51) Int. Cl. H04B 10/116; G01S 13/93; G08G 1/16; G05D 1/02

(52) U.S. Cl. CPC H04B 10/116; G01S 13/931; G05D 1/0268; G05D 1/0231; G08G 1/163

(57) ABSTRACT

A system and method for resolving the angle of the transmitter and the angle of the receiver when determining vehicle position using light based communication (LBC) signals. Each vehicle includes an LBC system having light emitting diodes (LEDs) and receiver photodiodes capable of sending and receiving pulsed light binary messages. Each LBC system has a controller coupled to the transmitter diodes and receiver diodes. The controller includes a processor configured to resolve the angle of the transmitter and the angle of the receiver. The angle of the receiver may be determined using a single digital message received at a first receiver and a second receiver on a receiving vehicle. The angle of the transmitter may be determined using a first digital message and a second digital message received at a same receiver on the receiving vehicle.

### FIELD OF THE DISCLOSURE

The present disclosure relates to light-based communication systems, and more particularly to light-based communication systems that may be used to determine vehicle position.

### BACKGROUND

Determining the position and distance between vehicles on a roadway is crucial for various autonomous automotive applications. Primarily in safety critical situations, an advanced driver assistance system (ADAS) of a vehicle may automatically alert and/or assist the driver if a collision is imminent. In addition, vehicle position estimation is also important for autonomous vehicle navigation and mapping. The position of a vehicle relative to another vehicle or roadway infrastructure provides information to the planner and the navigation system in determining alternate routes or potential hazards.

### BRIEF DESCRIPTION OF THE DRAWINGS

FIG. 1 illustrates a perspective top view of a vehicle having at least four light based communication (LBC) systems, in accordance with an embodiment of the present disclosure.

FIG. 2 illustrates a block diagram showing the components of an LBC system, in accordance with an embodiment of the present disclosure.

FIGS. 3A, 3B, and 3C illustrate a top view of a simplified vehicle-to-vehicle environment, showing a transmitting vehicle and a receiving vehicle, in accordance with an embodiment of the present disclosure.

FIG. 4 illustrates a perspective top view of an overlap region that may result from two adjacent light sources, in accordance with an embodiment of the present disclosure.

FIG. 5 illustrates a perspective aerial view of two ground vehicles and the various regions of communication coverage provided by the LBC systems of the vehicles, in accordance with an embodiment of the present disclosure.

FIG. 6 illustrates an example graphical diagram showing the relative photodiode pulse amplitude as a function of the angle of a first transmitter with respect to a second transmitter, in accordance with an embodiment of the present disclosure.

FIG. 7 illustrates an example graphical diagram of the various ratios of signal amplitude as a function of angle of a first transmitter with respect to a second transmitter, in accordance with an embodiment of the present disclosure.

FIG. 8A illustrates an example methodology for resolving an angle by first determining the angle of the transmitter element, and then determining the angle of the receiver element, in accordance with an embodiment of the present disclosure.

FIG. 8B illustrates an example methodology for resolving an angle by first determining the angle of the receiver element, and then determining the angle of the transmitter element, in accordance with an embodiment of the present disclosure.

FIG. 9 illustrates a perspective top view of a vehicle having a plurality of zones of communication, implementing a timing scheme, in accordance with an embodiment of the present disclosure.

FIG. 10 illustrates a perspective view of a side headlight or taillight assembly, as a cylindrical post structure, in accordance with an embodiment of the present disclosure.

FIG. 11 illustrates a perspective view of a headlight or taillight assembly, as a curved substrate structure, in accordance with an embodiment of the present disclosure.

FIG. 12 illustrates a perspective view of a side mirror assembly implementing a driver side LBC system having one or more optical transmitter elements and one or more optical receiver elements, in accordance with an embodiment of the present disclosure.

FIG. 13 illustrates a more detailed view of a portion of the side mirror assembly of FIG. 12, in accordance with an embodiment of the present disclosure.

FIG. 14 illustrates a top perspective view of the assembly of FIG. 13 in accordance with an embodiment of the present disclosure.

### DETAILED DESCRIPTION

Techniques are disclosed for determining vehicle position with respect to another vehicle or an infrastructure using light based communication (LBC). As will be appreciated, the techniques may be embodied in a system. In one such example system, light-based digital messages (LBC messages or other pulsed optical messages) are used in combination with a signal parameter of the digital message (such as a received signal strength indication (RSSI) or signal-to-noise ratio (SNR) value) to estimate the position of the vehicle. Each vehicle may be equipped with one or more LBC systems to communicate with another vehicle using digital messages. Each LBC system may include a transmitter having one or more optical transmitter elements, such as an array of light emitting diodes (LEDs), and a receiver having one or more optical receiver elements, such as an array of photodiodes, for transmitting and receiving LBC messages between the vehicles. In some cases, adjacent diodes (transmitting light emitting diodes or receiving photodetector diodes) may have an overlap region, for example in which a receiver element on a receiving vehicle is able to view a portion of two distinct, adjacent transmitter elements. Likewise, there may be an overlap in receiving a signal where the transmitted signal overlaps with two adjacent receiver elements. The overlap regions may be used in resolving the angle at which the transmitter and receiver are positioned with respect to each other. Both angle and distance are used to determine the relative position of one vehicle with respect to another vehicle. For the purposes of this disclosure, it is assumed that the distance between the two vehicles is known by independent measurement, and thus the present disclosure focuses on techniques for discerning the relative angles of the vehicles.

General Overview

Implementing an LBC system involves a number of non-trivial issues, particularly in communicating between vehicles. For example, some methods for real-time communication in a connected vehicle environment require broadcast transmission in an omnidirectional pattern. Dedicated short range communications (DSRC) data is an example broadcast transmission in a radio-based 360-degree field and all recipients receive the same information. As more vehicles join the connected vehicle network in dense traffic situations, the network may experience congestion and bottlenecks because every vehicle is broadcasting messages. DSRC and other methods use GPS alone or in combination with sensors on the vehicle. GPS generally requires the GPS receiver on the vehicle to have an unobstructed line-of-sight (LOS) view of at least four GPS satellites. GPS has limitations in determining vehicle location due to estimation error (which is typically greater than 1 m, but may be 10 m or greater) and satellite obstruction (which may be caused by tunnels, parking garages, shadowing by tall buildings, etc.). Omni-directional strategies (for example, DSRC) may result in further ambiguities, as there may be an overlap region where more than one transmitter element may be ‘visible’ to (i.e., within the field of view of) a receiver element, or where multiple receivers receive a signal from a same transmitter. This may result in ambiguities in trying to determine the location of the transmitter with respect to the receiver when the overlap exists, because it is unclear to which transmitter the RSSI should be attributed. There is a need, therefore, for directional, specified messages to be transmitted and received, to estimate the position of a vehicle, and provide other appropriate information within the messages. There is a further need for positional, distance based, or proximity based communication that accounts for the overlap region between adjacent diodes.

Thus, in accordance with an embodiment of the present disclosure, a system is provided for resolving the angle of the transmitter and the angle of the receiver used in determining relative vehicle position using light-based digital messages. An LBC message is a pulsed light-based digital message that is transmitted and received using light based communication. The vehicles implement LBC systems that use a signal parameter of the digital message to determine the relative location of one vehicle with respect to the other vehicle. In an embodiment, the LBC system includes a transmitter array of LEDs or other optical transmitter elements and a receiver array of photodiodes or other optical receiver elements. Both the transmitter and receiver arrays are deployed or installed on the vehicle and are coupled to a controller. The controller may be coupled to a memory having one or more program(s) that are executable by a processor of the controller. The overlap region between adjacent transmitters of the transmitting LBC system may be used to further define the angle of the transmitter with respect to a reference point, such as the 0-degree normal, of the vehicle. For example, using the overlap region of the transmitter element, one receiver element may be used to determine the angle of the transmitter based on two messages received, respectively, from two adjacent transmitter devices. Likewise, the overlap region between adjacent receivers of the receiving LBC system may be used to further define the angle of the receiver with respect to a reference point, such as the 0-degree normal, of the receiver vehicle. For example, two receivers may be used to determine the angle of the receiver based on a single message from a single transmitter that is received at both receivers, and using the overlap region of the receiver, to resolve the angle of the receiver. The distance between the two vehicles may be determined independently, for example using time-of-flight methods as implemented using the same light transmitter and light receiver hardware, or by performing triangulation using the RSSI.

LBC-equipped vehicles in close proximity to each other are able to estimate vehicle pose more accurately because, in part, as the vehicles become closer together, the received signal strength indicator (RSSI) becomes larger. Thus, as one vehicle becomes closer to another vehicle, the RSSI becomes larger, and likewise the RSSI decreases as the vehicles move away from each other. Thus, contrary to GPS, the accuracy improves as the vehicles become closer together. It is also true, however, that as the RSSI becomes larger and is easier to detect, this may also cause an overlap area to increase, which may make it difficult to determine which transmitter is transmitting a particular light-based digital message. To address this, the overlap region itself may be used as a parameter to further resolve any ambiguities regarding the angle of the transmitter or the angle of the receiver.

Light-Based Communication (LBC) System

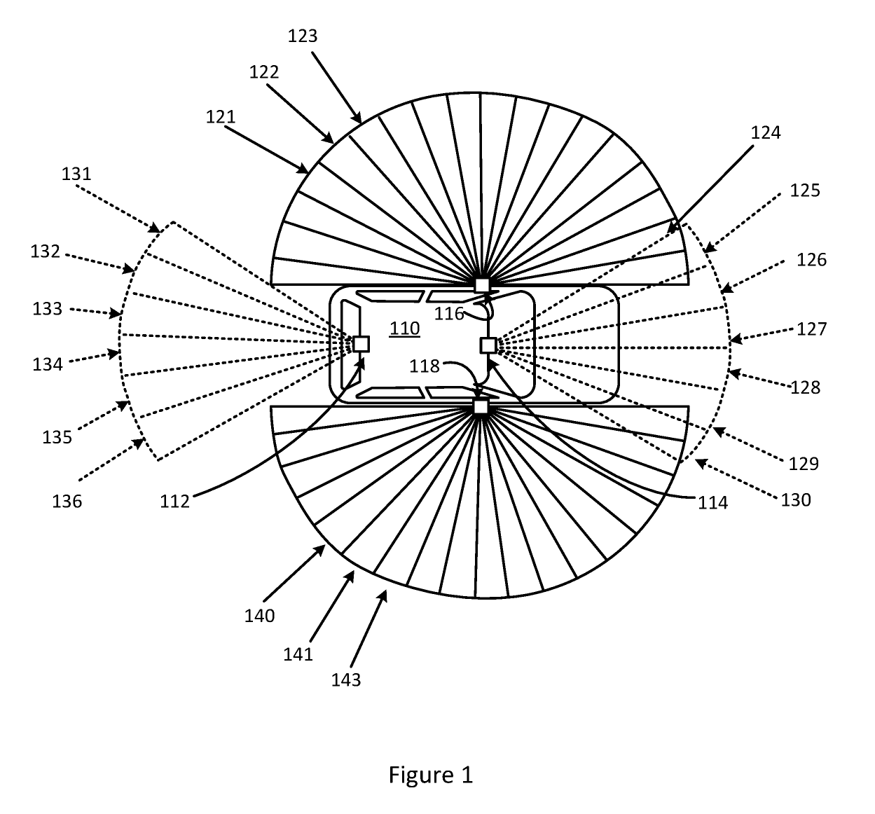

FIG. 1 illustrates a perspective top view of a vehicle having at least four light based communication (LBC) systems, in accordance with an embodiment of the present disclosure. The LBC systems allow for vehicle-to-vehicle or vehicle-to-infrastructure communication to determine the position of a first vehicle with respect to another vehicle or an infrastructure.

As shown in FIG. 1, the vehicle 110 includes four LBC systems, including a rear LBC system 112, a front LBC system 114, a driver side LBC system 116 and a passenger side LBC system 118, in accordance with an embodiment of the present disclosure. The driver side LBC system 116 has a plurality of light emitting diodes, or another optical transmitter element, that each has its own separate region of communication, which when transmitting, may be considered a zone or “cone” of transmission when transmitting, and may be set to a specified angle. The driver side LBC system 116 may include, for example the zones of transmission 121, 122, 123, and 124. The front LBC system 114 includes the zones of transmission 125, 126, 127, 128, 129, and 130. The rear LBC system 112 includes a plurality of light emitting transmitter elements, each having its own respective zone of transmission, for example the zones of transmission 131, 132, 133, 134, 135, and 136. The passenger side LBC system 118 includes a plurality of light emitting diodes, each having its own separate zone of transmission, for example the zones of transmission 140, 141, and 143. As shown, the vehicle 110 has four LBC systems, which provide 48 total optical transmitter elements, shown as rear 112 having 6 channels, front LBC system 114 includes 6 channels, and each side LBC system 116 and 118 has 18 channels, to provide a total of 48 channels. These channels may refer to individual channels of a multi-channel optical transmitter element, or individual optical elements, such as LEDs.

It will be appreciated that, although the zones of communication are depicted as having approximately the same angle of transmission as its respective neighbors, in some embodiments the angle of each diode may be varied so that adjacent diodes do not have the same angle of transmission. In some embodiments, the angle may be uniform for all of the diodes that are part of the LBC system. It will also be appreciated that although each LBC system is described as having a plurality of optical transmitter elements (e.g., LEDs), there may be a multi-channel optical transmitter element, having multiple separate channels that each have a separate zone of communication. In some embodiments, each optical transmitter element may have its own LBC system, resulting in multiple LBC systems per vehicle (48 in this example), or in some embodiments a single LBC system may be provided, having multiple optical transmitter elements or one or more multi-channel optical transmitter elements coupled thereto.

Note that there is an overlap with one of the zones of transmission of the driver LBC system 116 is overlapping with the zone of transmission 125 of the front LBC system 114, and another zone of transmission of the driver LBC system 116 is overlapping with the zone of transmission 126 of the front LBC system 114. There is also an overlap between the zone of transmission 129 and 130 and two zones of transmission of the passenger side LBC system 118. Also note that there is an overlap between the zone (or region) of communication 136 of the rear LBC system 112 and one of the zones of communication of the passenger side LBC system 118. This overlap region may be used to resolve potential ambiguities when determining the relative angle of a vehicle, and more particularly the angle of one receiver on a receiving vehicle with respect to one transmitter on a transmitting vehicle.

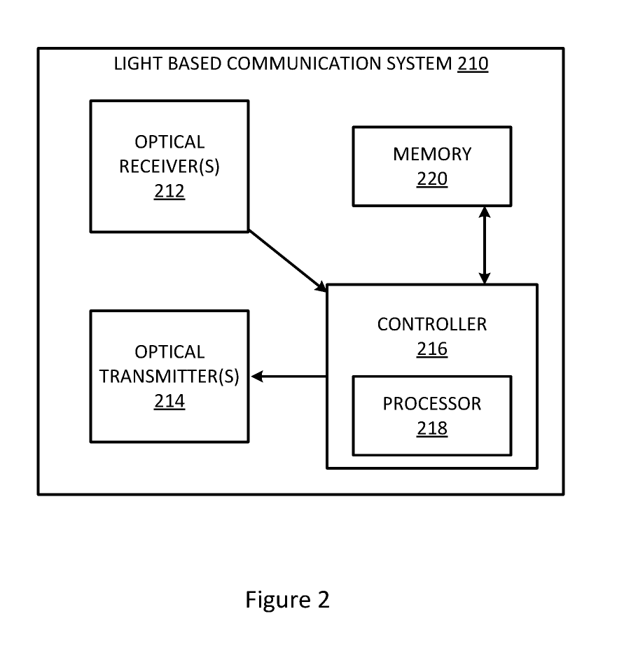

FIG. 2 illustrates a block diagram showing the components of an example LBC system, in accordance with an embodiment of the present disclosure. Each vehicle may include one or more LBC systems to communicate with other vehicles, in accordance with an example embodiment. In some embodiments, a single LBC system may be implemented, having a plurality of optical receiver elements (e.g., photodetectors) and a plurality of optical transmitter elements (e.g., light emitting diodes) operatively coupled thereto. In some embodiments, multiple LBC systems may be implemented on each vehicle, each coupled to one or more optical receiver elements and one or more optical transmitter elements, as will be appreciated in light of the present disclosure.

An example LBC system 210 includes one or more optical transmitter elements 214 and one or more optical receiver element(s) 212, each coupled to a controller 216. The optical transmitter elements 214 may be LEDs or other optical light sources and the optical receiver elements 212 may be photodiodes or other optical receiver elements, in accordance with an embodiment of the present disclosure. The controller is executable by a processor 218 and is coupled to memory 220 which may have one or more programs stored thereon that may be executable by the processor 218. The optical transmitter element(s) 214 may be used to transmit light signals (or other digital messages) to an LBC system of another (receiving) vehicle, and may also be used to send a time-of-flight pulse or other information when applicable. The optical receiver element(s) 212 may be used to receive light signals (or other digital messages) sent from one or more optical transmitter elements of another (receiving) vehicle, and may also be used to receive a time-of-flight pulse when applicable.

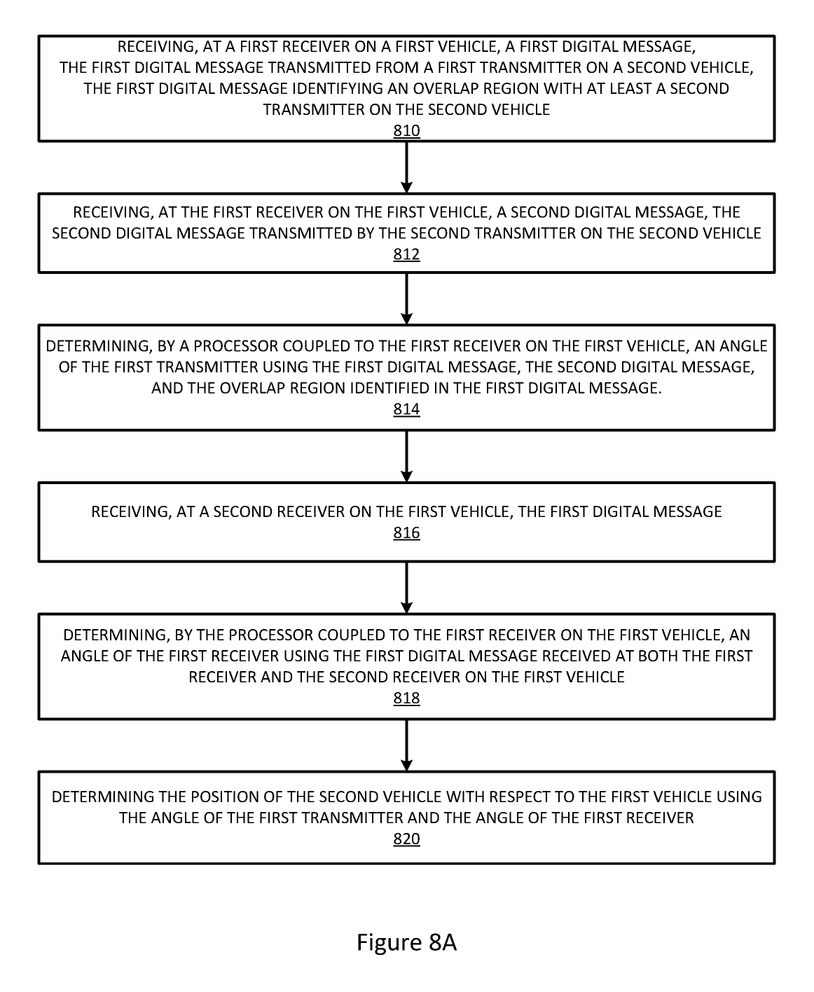

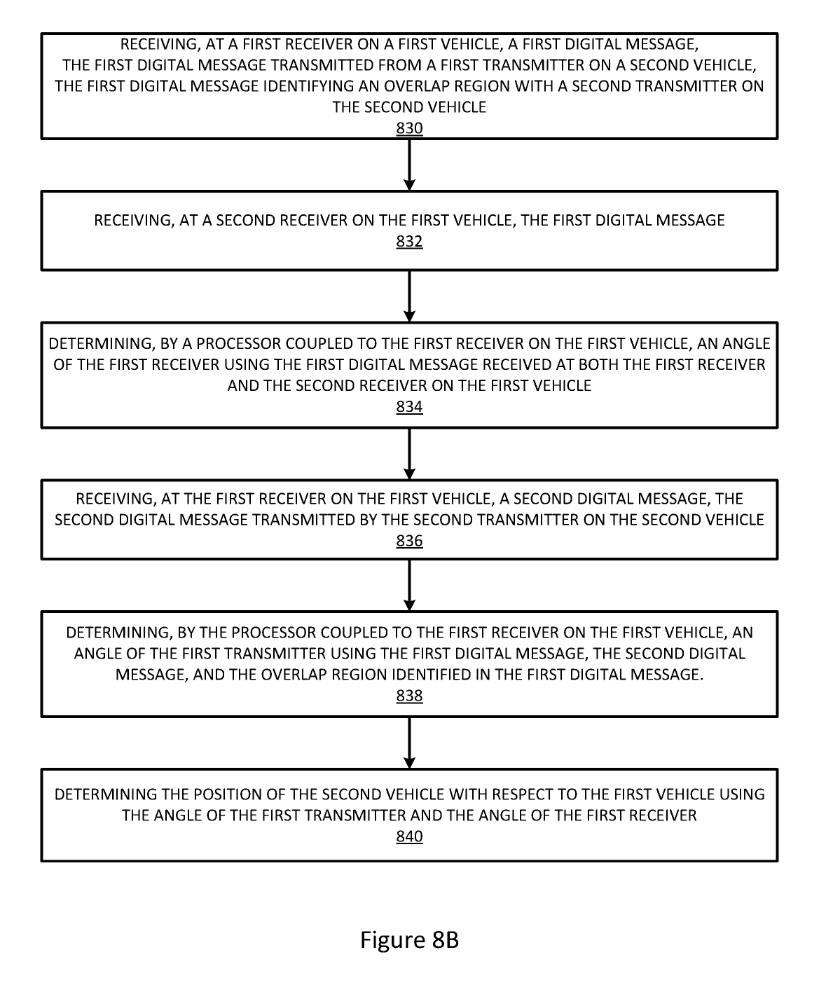

The controller 216 is coupled to a memory 220 that includes one or more programs that are executable by a processor 218, depending upon the data analysis and processing to be performed, as will be appreciated in light of the present disclosure. The memory 220 may include any appropriate structure or format for storage of data, including random access memory (RAM), read only memory (ROM), FLASH memory, or any combination thereof. The processor 218 may execute a program stored in memory 220 to determine the relative angular position of two vehicles, in accordance with an example embodiment. Refer, for example, to FIGS. 8A and 8B for example methodologies that may be implemented as a program stored in memory 220 for determining relative angular position when executed by the processor 218 to resolve the angle of the transmitter or the angle of the receiver. A plurality of programs may be stored in an appropriate memory 220 of the LBC system and may be executable by the processor 218 to perform various tasks related to transmitting and receiving optical signals, as will be appreciated in light of the present disclosure.

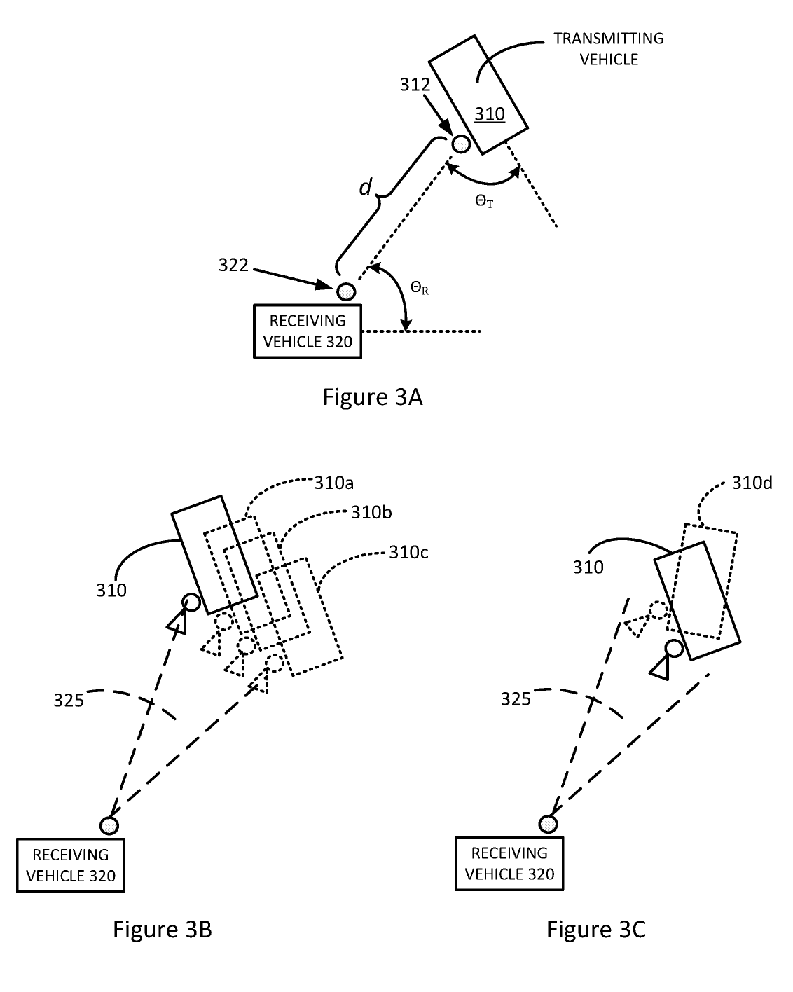

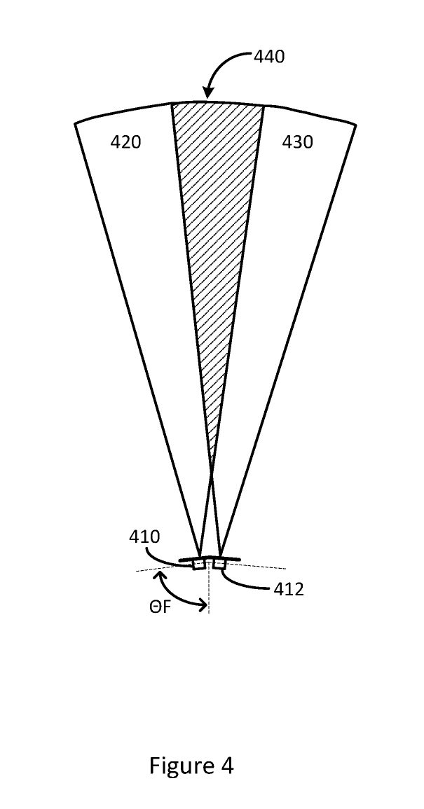

As shown in FIG. 3A, in order to determine the relative position of a transmitting vehicle 310 with respect to a receiving vehicle 320, at least two parameters need to be known or determined, including the distance, d, and the angle relative to the receiving vehicle, θ_{R}. In order to also determine the orientation of the transmitting vehicle 310, the angle relative to the transmitting vehicle, θ_{T}, needs to also be known or determined. These parameters are shown in FIG. 3A for a transmitter 312 on a transmitting vehicle 310 with respect to a receiver 322 on a receiving vehicle 320. The distance, d, the angle of the receiving vehicle (θ_{R}) and the angle of the transmitting vehicle (θ_{T}) may be used to determine the relative position of the transmitting vehicle 310. Even in situations in which the distance d is uniquely defined, there may be some ambiguities that arise due to uncertainties in the relative position of the transmitting vehicle 310 and the receiving vehicle 320. Reference is made to FIGS. 3B and 3C showing at least two ambiguities that can arise in determining the relative position of one vehicle with respect to another vehicle. For example, the transmitted messages from a transmitting vehicle may be received from any angle within the solid angle defined by a receiver's acceptance cone. As shown in FIG. 3B, the receiving vehicle 320 has an acceptance cone 325. There are multiple possible locations of the transmitting vehicle 310, and its corresponding transmitter 312, within the acceptance cone 325 of the receiver 322 on the receiving vehicle 320. For example, the transmitting vehicle could be at position 310, or position 310a, or at position 310b, or at position 310c. Resolving the angle of the receiving vehicle resolves this ambiguity. As shown in FIG. 3C, this may also result in multiple possible orientations of the transmitting vehicle 310 within the acceptance cone 325 of the receiver 322 on the receiving vehicle 320. The transmitting vehicle could be at position 310 or at position 310d, and by resolving the angle of the transmitting vehicle, this ambiguity may be resolved.

It is therefore desirable, as shown in FIG. 3A, to determine both the angle relative to the receiving vehicle (θ_{R}) and the angle relative to the transmitting vehicle (θ_{T}) to overcome the ambiguities illustrated in FIGS. 3B and 3C. By determining both the angle of the receiving vehicle and of the transmitting vehicle to a sufficiently high degree of resolution, a more exact determination of relative vehicle position and orientation is achieved.

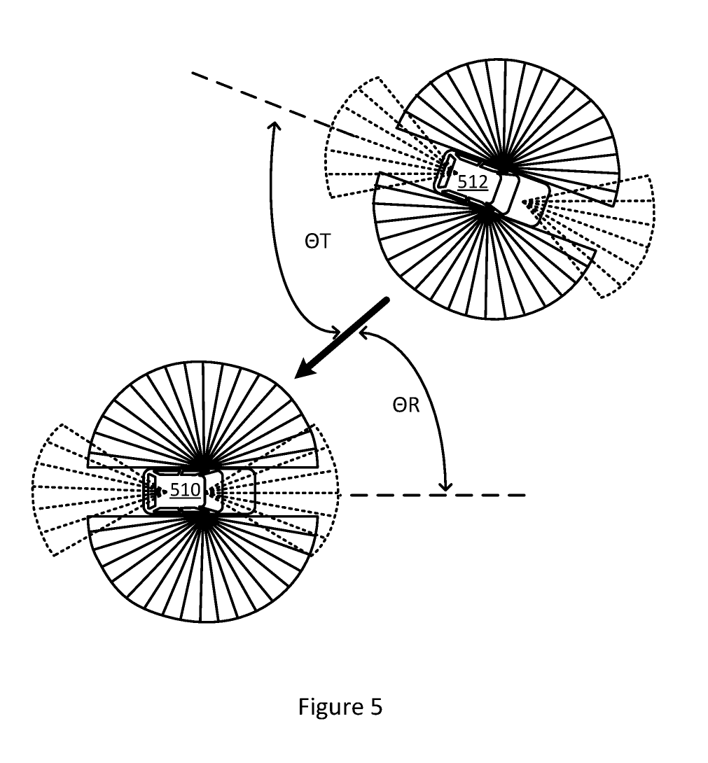

Reference is made to FIG. 4, showing a perspective top view of an overlap region that may result from two adjacent optical transmitter elements, in accordance with an embodiment of the present disclosure. FIG. 4 shows two optical transmitter elements 410 and 412, which are offset with respect to each other by an angle (180−2·θF), so that they provide a wide span of coverage. In some embodiments, θF may be approximately 2 to 30 degrees. Note that the overlap region becomes larger (i.e., wider) as the distance away from the optical transmitter elements increases. Although shown and described regarding an optical transmitter element, it will be appreciated that these techniques are likewise applicable to an optical receiver element. Each optical transmitter element 410 and 412 may include a light emitting diode or other optical transmitting device. The optical transmitter 410 has the zone 420 of transmission, which is the three-dimensional (3D) cone in which the optical light is visible, and the optical transmitter 412 has the zone 430 of transmission, which is the cone in which the optical light is visible, as shown in simplified two-dimension for illustrative and descriptive purposes, but likewise are applicable to three-dimensional systems.

An overlap region 440 results from the overlap of the first zone 420 of transmission from the first transmitter 410 and the second zone 430 of transmission from the second transmitter 412. Each of the transmitters 410, 412 may be a separate LBC system, or may be two transmitter devices under control of a single controller as part of one LBC system. The overlap region 440 is generally known to each of the transmitters 410 and 412 so that it may be used as a factor in determining the distance between a first vehicle and a second vehicle.

It will be appreciated in light of the present disclosure that data received from two (or more) transmitter elements, and the overlap between the transmitter element and its adjacent transmitter element, may be used by a processor coupled to the receiver element to determine the angle of the transmitter with respect to a reference point, such as the 0-degree normal of the vehicle. In some embodiments, the 0-degree normal may be parallel to the axis of travel of the vehicle. Likewise, two adjacent receiver elements and a single transmitter element, and the overlap region of the two receiver elements, may be used to determine the angle of the receiver with respect to a reference point, such as the 0-degree normal of the vehicle. Similarly, although the overlap of the transmitter with respect to its adjacent transmitter is generally transmitted as part of the message because it is not known to the receiver, the overlap region of the receivers is known, and thus may not be transmitted as part of the digital message.

Although FIG. 4 only shows the overlap that results from two adjacent transmitter elements, it will be appreciated in light of the present disclosure that a more complicated overlap region may result from multiple adjacent optical transmitter elements. For example, a portion of the zone of communication for each of three or more adjacent elements may overlap and define an overlap region. This overlap region is known to the transmitter, and may be transmitted as part of the message so that it is likewise known to the receiver. Thus, the receiver may use the known overlap region to resolve the angle of the transmitter element and the angle of the receiver element.

Resolving Angle of Transmitter and Angle of Receiver

It will be appreciated in light of the present disclosure that various techniques are available for determining the distance between a first vehicle and a second vehicle, and that this disclosure is focused on resolving the angle of the transmitter and/or the angle of the receiver to more accurately determine the angular position and angular orientation between a first vehicle and a second vehicle along a horizontal plane corresponding to a typical roadway.

FIG. 5 illustrates a block diagram of a top perspective view of two vehicles 510 and 512 in accordance with an embodiment of the present disclosure. The angular resolution component of the relative vehicle positioning system may be separated into two parts, including the angle of the transmitting vehicle 512, shown as θT, and the angle of the receiving vehicle 510, shown as θR. Refer, for example, to FIGS. 8A and 8B showing example methodologies for obtaining a higher resolution of θT, by any given receiver on a vehicle, and for obtaining a higher resolution of θR, by using two receivers. By resolving the angle of the transmitting vehicle, θT, and the angle of the receiving vehicle, θR, the angular position and orientation between the transmitting vehicle 512 and the receiving vehicle 510 may be resolved without ambiguities. This is true even when there is an overlap in the transmitted signals that are received at a receiving vehicle.

It will be appreciated in light of the present disclosure that resolving θT includes a single receiver receiving a first digital message transmitted from a first transmitter and a second digital message from a second transmitter in which a processor coupled to the receiver uses the received signal strength of the first message and of the second message and the overlap therebetween to resolve the angle of the transmitter. Likewise, resolving θR includes a first receiver using a first digital message transmitted from a first transmitter that is received at both the first receiver and a second receiver adjacent to the first receiver, in which a processor coupled to the first receiver uses the received signal strength of the first digital message as seen by both the first receiver and the second receiver, and the overlap region therebetween, to resolve the angle of the receiver, as will be appreciated in light of the present disclosure.

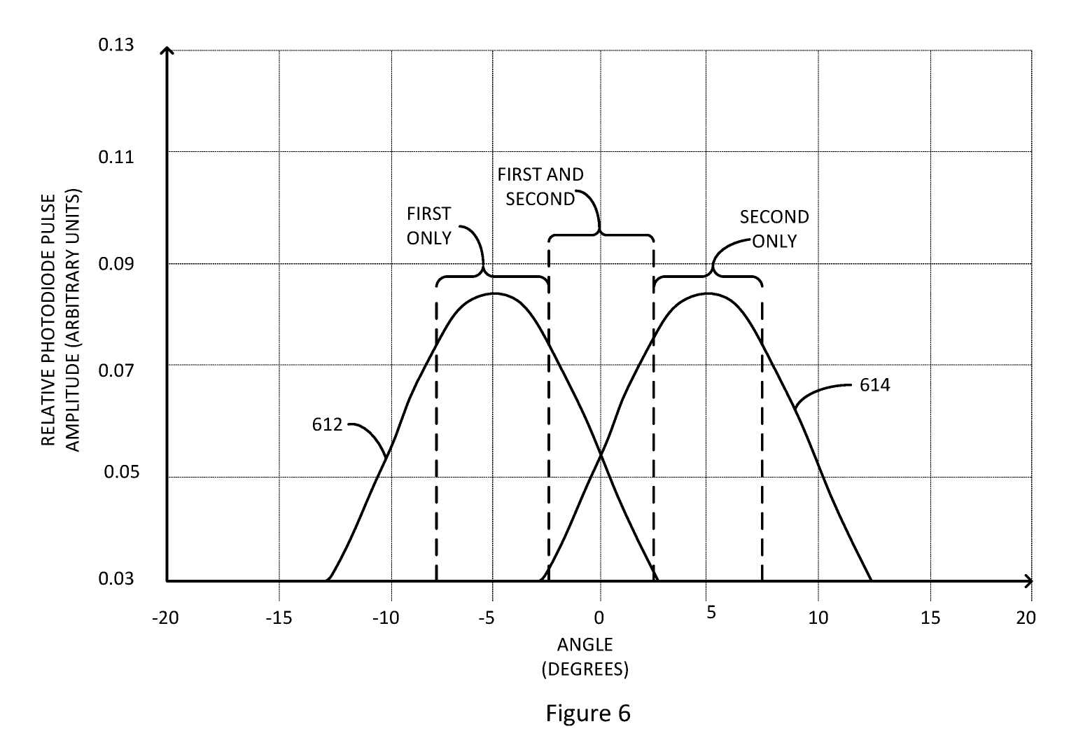

Reference is now made to FIG. 6 showing an example graphical diagram of the relative photodiode pulse amplitude (in arbitrary units) as a function of the angle (in degrees) for two optical transmitter elements incident upon a receiver element, in accordance with an embodiment of the present disclosure, similar to the embodiment of FIG. 4. The amplitude of each optical transmitter element may be measured or otherwise obtained as a function of the angle of the transmitter (with respect to a 0-degree normal) to provide a plurality of points. The angle of the transmitter may be measured with respect to a center line through the vehicle (at 0-degrees) or another point of reference known to the vehicle and the LBC system(s). For example, as shown in FIG. 5, θT is the angle of the transmitter with respect to the 0-degree normal of the transmitting vehicle. In FIG. 6, the points of amplitude as a function of the angle of the transmitter (relative to the 0-degree normal) are shown plotted on a graph, and line 612 represents the amplitude of the first transmitter element, and line 614 represents the amplitude of the second transmitter element as a function of the angle of each transmitter element. As shown, this graph may be used to determine the angles at which the first transmitter is detected by a receiver, the angles at which the first and second are present, and the angles at which the second transmitter is present. As shown by the brackets in the FIG. 6, it is possible to discern the region for the first transmitter element, the region for both the first and second transmitter element (where the overlap exists), and the region for the second transmitter element. The graph is effectively a measure of light intensity as a function of angle, and should correlate with the optical beam pattern of each transmitter element, as will be appreciated in light of the present disclosure. This graph may be created based on experimental data gathering of amplitude at various angles, or may be known by the transmitter based on measurements of the vehicle and the various optical elements, and may be pre-programmed in the vehicle memory or in a local memory of each optical transmitter element and each optical receiver element.

The boundaries of the region identified in FIG. 6 as representing an overlap region for both the first transmitter and the second transmitter (the middle bracket) may be determined. This may occur by calculating the ratio of the y-axis values at the uppermost intersection points and the lower intersection points of the lines, which are approximately 0.070 and 0.030, respectively, in this example. Division of these two values yields a ratio of 2.33, which is a value that may easily be included in the header of each transmitted message so that future ratio values may be compared to this threshold value. As such, the receiving vehicle divides the higher signal value by the lower signal value. If the calculated ratio is less than the value specified in the transmission message header (i.e., less than the threshold value), the source transmission is located within the overlap region. If the ratio is higher, then the receiver will defer to the higher of the two signals and assign the source of transmission to be located in the span either for the first transmitter or for the second transmitter.

These and several other ways of using the message signal data for the purpose of increasing the angular resolution of the messages received at the receiver, as will be appreciated in light of the present disclosure. Refer, for example, to FIGS. 8A and 8B showing example methodologies, in accordance with an embodiment of the present disclosure.

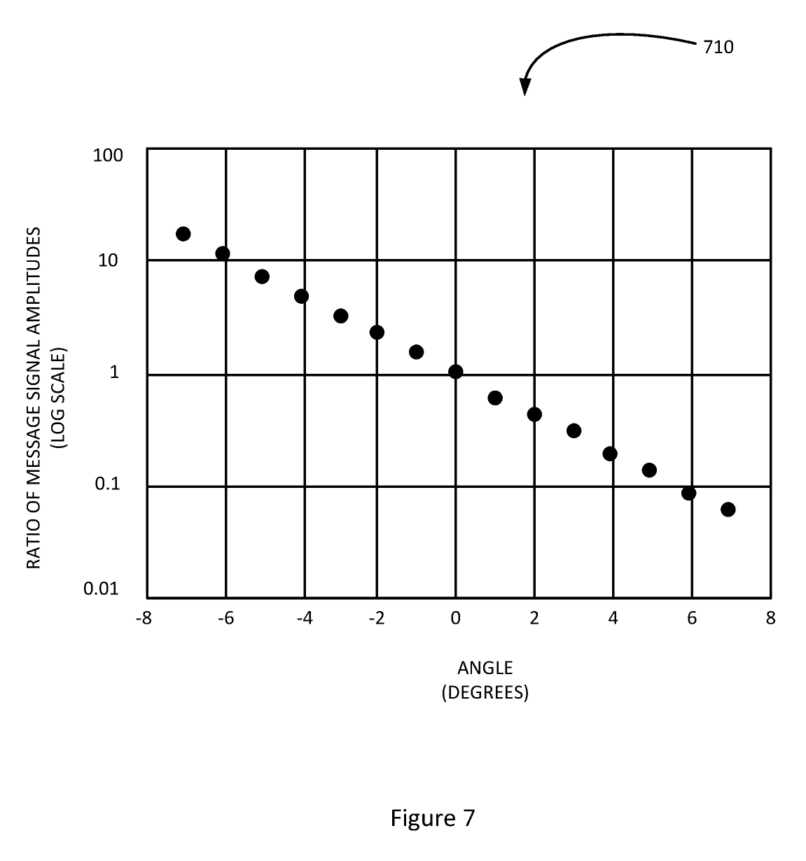

Reference is made to FIG. 7 showing an example graphical diagram of the ratios of the signal amplitudes of two adjacent transmitters as a function of the angle defined by a signal collected by a receiver positioned within the overlap region of those transmitters, in accordance with an embodiment of the present disclosure. The graphical diagram 710 of FIG. 7 shows the ratios calculated at one degree increments for the hypothetical data of FIG. 6. As shown, the graphical diagram lines for each transmitter element (of the lines of FIG. 6) are now shown plotted as a ratio of message signal amplitudes collected at the first receiver as a function of angular position of the receiver relative to the pair of transmitters. This may be stored as a look up table or other data format, so that when the ratio of the signal amplitudes are determined by the receiving vehicle, the angle may then be determined. In some embodiments, the beam pattern characteristics may be fit to an equation, such as a polynomial fit, whereby smaller than one degree increments may be achieved. It is possible that it may be desired to minimize the use of calculations in favor of a relatively short table of values within the transmission message header, and it is also likely that one degree of accuracy is sufficient to provide the desired angular resolution. As such, a simple look-up table with values of ratios as a function of angle may be used to discern the angles. For example, the receiver on the receiving vehicle may provide the signal strength of the signal received from the first transmitter and the second transmitter of the transmitting vehicle to a processor coupled to the receiver. The processor may check the resulting ratio against a table of ratios of the transmitter intensity as a function of the angle (For example, as shown in FIG. 7) or may be a simple threshold value against which the resulting ratio is checked. This may be used to determine the angle of the transmitter on the transmitting vehicle.

The information contained in the graph of FIG. 7 may be stored as a graph, a function, or a lookup table in memory that is coupled to the transmitter. In some embodiments, the information may be transmitted to the receiver as part of the digital message, so that the receiver obtains the overlap region of adjacent transmitters.

It will be appreciated in light of the present disclosure that the principles for determining the angle of the transmitter may likewise be applied to the optical overlap of the receivers to resolve the angle of the receiver. More particularly, determining the angle of the transmitter involves two distinct messages from adjacent channels incident on one receiver, and thus the angle of the receiver may be determined using a single message that is incident on two adjacent receiver channels. Any incoming message from a transmitting vehicle has some probability of registering on both receivers. By dividing the signal strength (in the form of pulse amplitude, for example), of one receiver by that of the adjacent receiver, this results in a ratio that may be checked against previously computed, or otherwise stored, ratios of receiver sensitivity as a function of angle. In principle, this is the same strategy as was used for calculating the angle of the transmitter, except instead of relying on the header of the transmitted message to provide the ratio characteristics. The receiver ratio characteristics are already stored ad they relate to the design of the receiving vehicle system. The ratio characteristics of the receiver may be stored locally for each receiver element, or in multiple memory storage locations each coupled to one or more receiver elements, or in a single memory storage that is coupled to all of the receiver elements, as will be appreciated in light of the present disclosure.

Methodology

Reference is now made to FIGS. 8A and 8B showing example methodologies for resolving the angle of the transmitter and the angle of the receiver in a light based communication environment, in accordance with an embodiment of the present disclosure. It will be appreciated that either the angle of the transmitter or the angle of the receiver may be calculated first, or that only one of the angle of the transmitter or the angle of the receiver may be resolved. FIG. 8A illustrates a methodology for determining the angle of the transmitter first, and then determining the angle of the receiver; and FIG. 8B illustrates a methodology for determining the angle of the receiver first, and then determining the angle of the transmitter, in accordance with an embodiment of the present disclosure. The methods illustrated in FIGS. 8A and 8B may be performed by a processor of a LBC system, such as the processor 218 in the LBC system 210 shown in FIG. 2.

FIG. 8A shows an example methodology for resolving the angle of a transmitter and the angle of a receiver, in accordance with an embodiment of the present disclosure. The methodology commences at block 810 by receiving, at a first receiver on a first (receiving) vehicle, a first digital message. The first digital message is transmitted from a first transmitter on a second vehicle, and the first digital message identifies an overlap region of the first transmitter with at least one second transmitter on the second (transmitting) vehicle that is different from, and adjacent to, the first transmitter on the second (transmitting) vehicle. At block 812, the methodology continues by receiving, at the first receiver on the first vehicle, a second digital message. The second digital message is transmitted by a second transmitter on the second (transmitting) vehicle. In operation, each of the two optical transmitter elements transmits a digital message by visible light communication or light-based communication, in accordance with an embodiment of the present disclosure. The first digital message transmitted by the first optical transmitter (for example transmitter 410 in FIG. 4) may be different from the second digital message transmitted by the second optical transmitter (for example transmitter 412 in FIG. 4). For example, the body portion of the first message and the second message may be the same, but there may be different headers for each message, in which the header may identify the specific transmitter location relative to the vehicle body. The header may also identify, with reference to FIG. 4, the overlap region 440 between adjacent transmitters 410, 412, as a lookup table, graph, or other appropriate format. This information contained in the header is used by the receiving vehicle to identify the angular resolution of a transmitter with respect to 0-degree normal of the vehicle, or another reference point on the vehicle. The body of the second digital message may be the same as the body of the first digital message with each message having a different header to provide additional identifying information. The additional information may include the rate of speed, a transmitter identifier number, an overlap region with an adjacent transmitter, or another identifier that provides the location of the transmitter with respect to the vehicle, as well as various safety and navigational information as may be required as part of future vehicle-to-vehicle communications standards, as will be appreciated in light of the present disclosure. For example, the rate of spread may differ for various light sources, in which a more diffuse light source has a cone that will get substantially wider as the distance away from the transmitter increases. However, a laser-like source cone will get wider at a much slower rate, and this information may be included in the message. Although the overlap is expressed as a ratio, and as such the rate of spread may not be relevant in all cases, but in some cases the additional information may be helpful. Other identifying information may be included in the header of the digital messages.

The first and second digital messages are received as optical signals, and the incoming stream of light pulses are analyzed to discern pulse sequences, as will be appreciated. The incoming photodiode signals are analyzed, and decoded if necessary, to interpret the transmitted message.

At block 814, the method continues by determining, by a processor coupled to the first receiver on the first vehicle, an angle of the first transmitter using the first digital message, the second digital message, and the overlap region identified (or otherwise specified) in the first digital message. The processor is able to determine the angle of the transmitter by measuring relative amplitude of messages received from two different transmitter elements, comparing the ratio of the overlap region to a look-up table or other information, and determining the angle therefrom, as will be appreciated in light of the present disclosure. For example, the receiver may provide the amplitude of the signals to the processor, and the processor measures the amplitude ratio by dividing the amplitude of one signal by the amplitude of another signal. The ratio is then compared to a look-up table or threshold value by the processor to determine the angle of the transmitter. The angle may then be used to determine the angular position and orientation between the transmitter and the receiver, now that the angle of the transmitter has been resolved and any potential ambiguities have been removed.

There are several methods of using the message data for increasing the angular resolution of the messages received at the receiver, as will be appreciated in light of the present disclosure. And likewise, for resolving the angle of the message transmitted at the transmitter. One method includes determining the ratio of the signal strength in accordance with an embodiment of the present disclosure. The boundaries of the region identified in FIG. 6 as representing an overlap region for both the first transmitter and the second transmitter (the middle bracket) may be determined. This may occur by calculating the ratio of the y-axis values at the uppermost intersection points and the lower intersection points of the lines, and division of these two values yields a ratio, which is a value that may easily be included in the header of each transmitted message so that future ratio values may be compared to this threshold value. As such, the receiving vehicle divides the higher signal value by the lower signal value. If the calculated ratio is less than the value specified in the transmission message header (i.e., less than the threshold value), the source transmission is located within the overlap region. If the ratio is higher, then the receiver will defer to the higher of the two signals and assign the source of transmission to be located in the span either for the first transmitter or for the second transmitter.

In another example embodiment, rather than a specific ratio number, a set of ratios may be included that specify the ratios at, for example, one degree increments (for example, the values of FIG. 7 provided in a table). These may be provided as a lookup table with a series of ratios and respective angles. In this case, the lookup table may specify which LED message signal belongs in the numerator and which one belongs in the denominator. In the example of FIG. 6, the three regions of interest include a total angular span of 15 degrees. As such, the transmission message header may contain 15 ratio values for which the receiver (and the associated microprocessor) may select the closest match or perform an interpolation, depending on the accuracy required and the capacity to do quick calculations. Finally, in embodiments in which the “other” adjacent beam pattern (from the opposite side) is also spatially present in the same zone, then it would be straightforward to adapt this method to utilize tables of data that specify the ratios of three signals as a function of (x:y:z).

At block 816, the methodology continues by receiving, at a second receiver on the first (receiving) vehicle, the first digital message, in accordance with an example embodiment of the present disclosure. This may be the first digital message received at the first receiver at block 810. Thus, the first digital message has now been received at the first receiver and the second receiver on the second (receiving) vehicle. At block 818, the method continues by determining, by the processor coupled to the first receiver on the first vehicle, an angle of the first receiver. In accordance with an embodiment of the present disclosure, the angle of the first receiver is determined using the first digital message which is received at both the first receiver and the second receiver on the first vehicle, as well as the receiver overlap region. As will be appreciated in light of the present disclosure, each receiver knows the overlap region that it has with respect to its adjacent overlap regions, and thus it may use this information to determine the angle of the receiver, combined with the level of illuminance of the first digital message with respect to the second digital message. Each optical receiver element may have an overlap region stored in local memory of the receiver or in another memory location that is accessible by the receiver or a processor or controller coupled to the receiver.

At block 820, the position of the second vehicle is determined with respect to the first vehicle using the angle of the first transmitter and the angle of the first receiver.

FIG. 8B illustrates the methodology in whichf the angle of the first receiver is determined first, and then the angle of the first transmitter is determined, to resolve any ambiguities in the angle of the transmitter and/or of the receiver, in accordance with an embodiment of the present disclosure. At block 830, the methodology commences by receiving, at a first receiver on a first (receiving) vehicle, a first digital message. In accordance with an embodiment of the present disclosure, the first digital message is transmitted from a first transmitter on a second (transmitting) vehicle, and the first digital message identifies an overlap region of the first transmitter with respect to a second transmitter on the second (transmitting) vehicle. At block 832, the methodology continues by receiving, at a second receiver on the first (receiving) vehicle, the first digital message. The first digital message is thus received at both the first receiver and the second receiver on the first vehicle. The methodology continues, at block 834, by determining the angle of the first receiver using the first digital message received at both the first receiver and the second receiver on the first vehicle. The processor coupled to the first receiver may determine the angle of the first receiver using the first digital message received at both the first receiver and the second receiver, as well as the receiver overlap region. As will be appreciated in light of the present disclosure, each receiver knows the overlap region that it has with respect to its adjacent overlap regions, and thus it may use this information to determine the angle of the receiver, combined with the level of illuminance of the first digital message with respect to the second digital message. Each optical receiver element may have an overlap region stored in local memory of the receiver or in another memory location that is accessible by the receiver or a processor or controller coupled to the receiver.

At block 836, the methodology continues by receiving, at the first receiver on the first vehicle, a second digital message. The second digital message is transmitted by the second transmitter on the second (transmitting) vehicle, such that the first message and the second message are received by the first receiver. The methodology continues at block 838 by determining, by the processor coupled to the first receiver on the first vehicle, an angle of the first transmitter using the first digital message, the second digital message, and the overlap region identified in the first digital message.

It will be appreciated in light of the present disclosure that the angle of the receiver or the angle of the transmitter may be determined first, with the other being calculated second, or that they may both be calculated at substantially the same time, once all pertinent data is obtained. Determining the angle of the first receiver element may be performed by a processor coupled to the receivers, using the first digital message received at both the first receiver and the second receiver, and the angle of the first transmitter may be determined using the first digital message and the second digital message received at the first receiver.

At block 840, the methodology continues by determining the position of the second vehicle with respect to the first vehicle using the angle of the first transmitter and the angle of the first receiver. It will be appreciated in light of the present disclosure that numerous techniques may be implemented to determine the distance of the second vehicle with respect to the first vehicle, and any ambiguities in the angle may be resolved by determining the angle of the transmitter and the angle of the receiver.

The data rates for transmission of messages should be fast enough that the time duration of any message is short enough, such that the physical travel speed (km/hr) of the transmitting vehicle does not result in only a partial message being received before that vehicle is no longer within line-of-sight (LOS) of the given receiver. Thus, for example, at 0.5 Mbps data rates, a 30 byte LBC message might theoretically transmit in 0.5 ms resulting in maximum 1.5 cm vehicle movement and a 300 byte LBC message would theoretically transmit in 5 ms resulting in maximum 15 cm vehicle movement, assuming a vehicle speed of 100 km/hr. Thus, in accordance with the techniques of the present disclosure, it is reasonable to assume that most of the time a vehicle will remain within the LOS zone of a targeted receiver for the duration of its transmitted message.

Timing of Transmission of Optical Signals

In accordance with an embodiment of the present disclosure, the robustness of the system may be still further enhanced by providing a timing scheme in which specific channels are assigned to one of a number of different message time slots. In some embodiments, it may be important that two digital messages do not overlap in time at the same receiver, as they may potentially not be interpretable. The various transmitters/receivers, or transmitter/receiver channels, may be configured to deliberately stagger the transmission of their optical signals so that two messages may be received from adjacent channels. For example, each channel or adjacent LED may be assigned to one of three different message time slots. In this manner, adjacent channels should not overlap in time, further refining the robustness of the light-based communication system by ensuring neighboring digital message are transmitted at different times. For example, the channels may be divided into three (or more) groups, in which the first group transmits a first optical signal, and there is a 10 millisecond (ms) delay before the second group transmits a second optical signal, and then another 10 ms delay before the third group transmits a third optical signal.

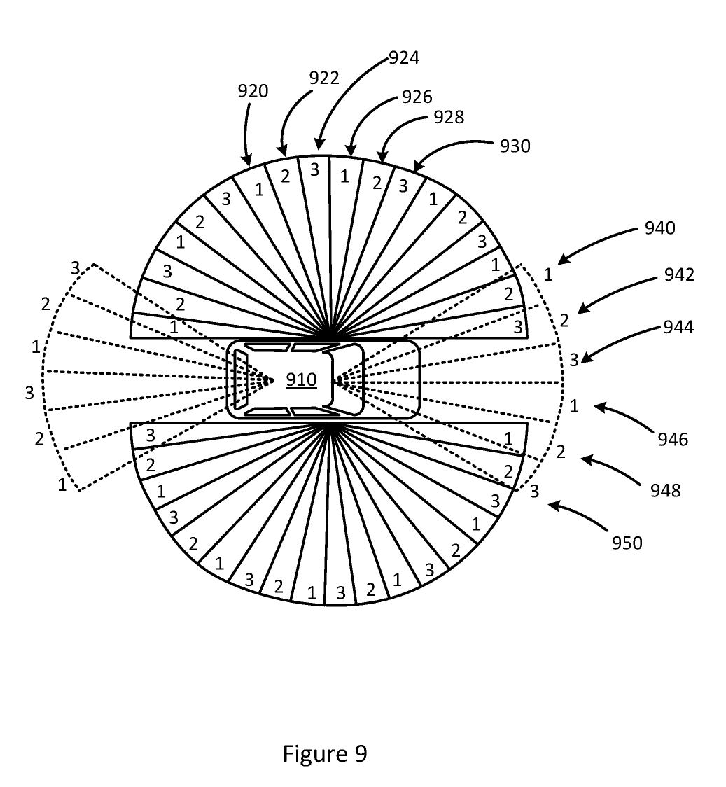

FIG. 9 illustrates a perspective top view of a vehicle 910 having a plurality of zones of communication, and implementing a timing scheme in accordance with an embodiment of the present disclosure. As shown in FIG. 9, the overall LBC system for the vehicle 910 includes 48 separate transmitter/receiver channels, each with a nominal 10-degree angular span in the horizontal plane in this example, to provide a broad 360-degree spread of coverage. For example, the driver side includes 18 transmitter/receiver channels, the passenger side includes 18 transmitter/receiver channels, the front includes 6 transmitter/receiver channels, and the rear includes 6 transmitter/receiver channels, to provide a total of 48 transmitter/receiver channels on the vehicle 910. As shown, the transmitter/receiver channels 920, 926, 940, and 946 are all included in the first group of channels, denoted by the number ‘1’. The transmitter/receiver channels 922, 928, 942, and 948 are all included in the second group of channels, denoted by the number ‘2’. The transmitter/receiver channels 924, 930, 944, and 950 are all included in the third group of channels, denoted by the number ‘3’. The digital message transmitted from each transmitter may further identify which group that the transmitter channel belongs to in order to further address any ambiguities that may result from the overlap of the zones of transmission of each transmitter channel. By specifying which group the transmitter element belongs to, it may be easier to determine the particular transmitter element that is transmitting a message in order to resolve the angle of the transmitter. It will be appreciated in light of the present disclosure that, although described as channels, the system of FIG. 9 may include multiple LEDs rather than a multi-channel LED, resulting in 48 individual LEDs. Other configurations that provide multiple optical transmitter elements will be apparent in light of the present disclosure.

For example, the channels may be divided into three (or more) groups, in which the first group transmits a first optical signal, and there is a 10 millisecond (ms) delay before the second group transmits a second optical signal, and then another 10 ms delay before the third group transmits a third optical signal. Each of the 48 channels may have one or more optical transmitter elements which transmit, in addition to a basic safety message, a unique header with information specific to the interpretation of that message, including but not limited to the location of the transmitter on the body. By assigning the channels to one of three different time slots, adjacent channels should not overlap in time. It will be appreciated that although the channels are shown and described as being divided into three groups, the channels may be divided into fewer or more than three groups in an embodiment, dependent on the spatial overlap of transmitting and receiving optical characteristics for specific vehicle designs.

The unique header for each message may also identify the angle between the transmitter channels, the ratio of adjacent transmitting channel signal intensity, and a coarse outline of the footprint of the transmitting vehicle relative to the transmitter. In accordance with an embodiment, the coarse outline may include the spatial coordinates of the four corners of the transmitting vehicle, thus outlining a rectangle in space.

Example Head Light, Tail Light, and Side Mirror Structure Implementations

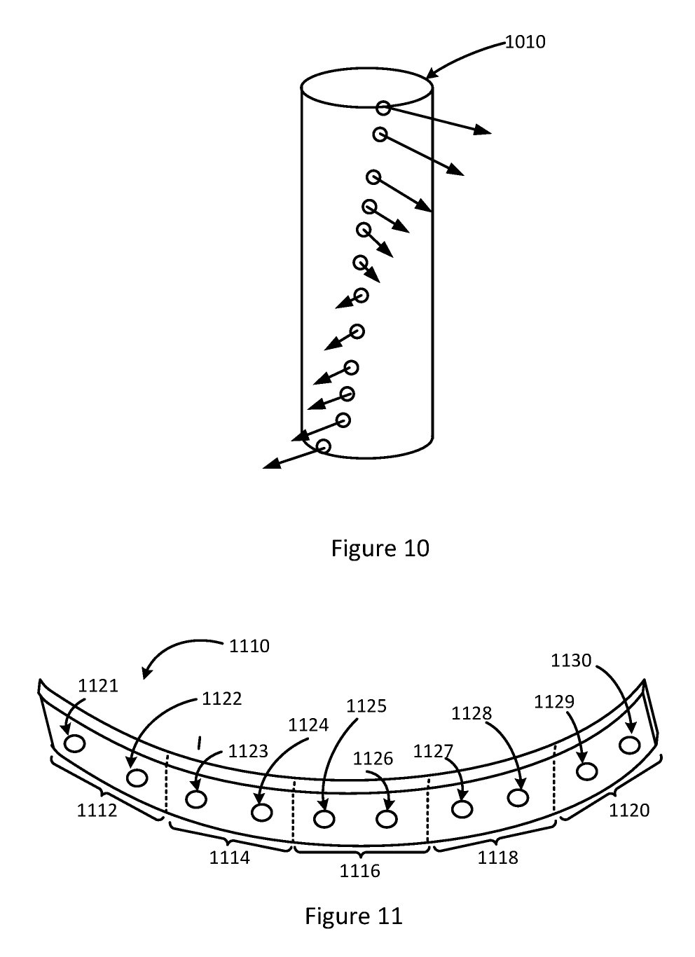

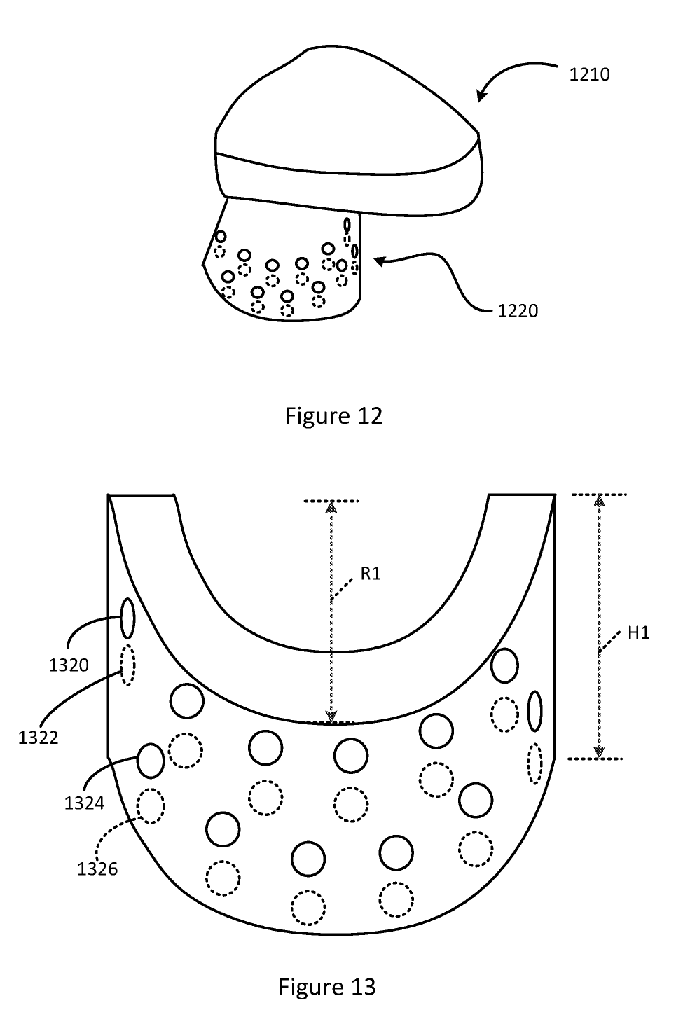

There are at least two additional options for providing the broad angular coverage, as will be appreciated in light of this disclosure. One option is for all of the optical transmitter elements and the optical receiver elements in an array to be uniformly installed within the same geometric plane (e.g., on a flat circuit board), while relying on the different lens characteristics to direct each optical transmitter element beam pattern to a different angle to achieve a wide beam spread. This may require expensive, specialized lenses, for example. Another option is to provide each optical transmitter element with the same type of lens, while relying on a curved substrate (e.g., circuit board) to aim optical transmitter elements in a slightly different direction. For example, as a cylindrical post shown in FIG. 10, a curved substrate shown in FIG. 11, or a curved side mirror installation shown in FIGS. 12 and 13.

FIG. 10 illustrates a perspective view of a cylindrical post-type assembly that may be a headlight or taillight implementation, in accordance with an embodiment of the present disclosure. As shown, a base 1010 having a cylindrical shape has a plurality of LEDs or other optical transmitter elements disposed thereon. Each of the optical transmitter elements may be offset along the cylinder to each have a different angle with respect to each other. It will be appreciated in light of the present disclosure that these techniques provide structures to achieve the angular resolution of the present disclosure. In accordance with some of the embodiments herein, the channels may utilize transmission optics with a 10 degree beam spread and photodiode collection optics with 10 degree acceptance angle. The angular value of 10 degrees is one example approximation, and other angles may be selected, as will be appreciated. Optical treatments may be asymmetric regarding horizontal and vertical beam spreads in some embodiments, where the beam spread is not symmetrical in the horizontal direction, or in the vertical direction, or in both horizontal and vertical directions.

It will be appreciated in light of the present disclosure that the term the “angle of the transmitter,” unless otherwise noted, refers to the angle of the transmitter with respect to the 0-degree normal of the vehicle (or another point of reference) whereas the “beam spread” refers to the actual angle of the cone of transmission of the transmitter. Likewise, the term the “angle of the receiver,” unless otherwise noted, refers to the angle of the receiver with respect to the 0-degree normal of the vehicle (or another point of reference) whereas the “acceptance angle” refers to the angle within with a particular receiver may receive a light-based digital message, also referred to herein as the zone or cone of communication of the receiver.

FIG. 10 illustrates a base 1010 forming a cylindrical post having a plurality of LEDs or other optical transmitters disposed thereon, in accordance with an embodiment of the present disclosure. The array of 12 LEDs are mounted in a vertical orientation and arranged in the same direction. Each optical transmitter element, due to its position on the base 1010, has a slightly different zone of transmission, as shown by each of the arrows in FIG. 10. The base 1010 may be a cylindrical post as shown, or may be a flat metal strip that has been half-twisted into a helical shape. The flexible circuit board may be adhered, or otherwise secured to, or integral with, a vehicle or other object, to enable each optical transmitter element of the array to be aimed at a progressively tilted angle. In the far-field, segmented angular coverage along the horizontal plane may be achieved due to the differing angles of neighboring optical transmitter elements.

FIG. 11 illustrates a perspective view of a curved substrate assembly that may be a headlight or a taillight assembly, in accordance with an embodiment of the present disclosure. FIG. 11 illustrates a horizontally bent substrate, for example which may be placed at a bottom portion of a headlight or taillight, such as within the directional signal, head lamp or tail light. The curved substrate 1110 includes a plurality of portions 1112, 1114, 1116, 1118, and 1120, shown joined by a dotted-line, which may represent a crease, fold, or other element that joins the portions together. Curved substrate portion 1112 includes optical transmitter elements 1121 and 1122, curved substrate portion 1114 includes optical transmitter elements 1123 and 1124, curved substrate portion 1116 includes optical transmitter elements 1125 and 1126, curved substrate portion 1118 includes optical transmitter elements 1127 and 1128, and curved substrate portion 1120 includes optical transmitter elements 1129 and 1130. Although each curved substrate portion 1112, 1114, 1116, 1118, and 1120 is shown as having two optical transmitter elements disposed thereon, each of the two optical transmitter elements may be aimed in the same direction, to effectively create a single optical transmitter element, or may be aimed in different directions so that each acts as a separate optical transmitter element that is offset from its adjacent neighbor by an angle, as will be appreciated in light of the present disclosure.

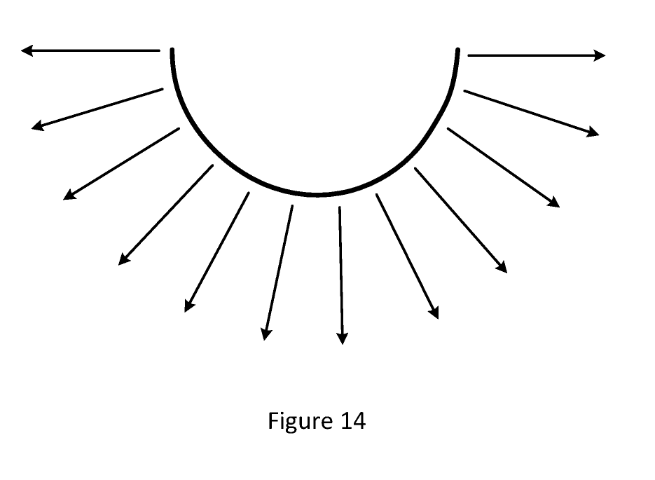

FIG. 12 illustrates a perspective view of a side mirror assembly, in accordance with an embodiment of the present disclosure. The side mirror assembly 1210 includes an LBC system 1220 having 12 LEDs, or other optical transmitter elements, and 12 photodiodes, or other optical receiver elements. Although 12 optical transmitter elements and 12 optical receiver elements are shown, any number of optical transmitter elements and optical receiver elements can be implemented, as will be appreciated in light of the present disclosure. Each optical transmitter element and optical receiver element pair are aimed in a different direction; spanning 180 degrees along the horizontal plane (refer, for example, to FIG. 14 showing the example angle span). The side mirror arrangement 1210 may be the driver side LBC system in FIG. 1 in an example embodiment. In this example, the optical transmitter elements are denoted by the solid line, and the optical receiver elements are the dashed-line circles, however any configuration and placement may be provided, as will be appreciated in light of the present disclosure.

FIG. 13 illustrates a more detailed view of a portion of the LBC system 1220 as part of a side mirror arrangement 1210, as shown in FIG. 12. The optical transmitter elements 1320 and 1324 are shown, as well as optical receiver elements 1322 and 1326. The side mirror arrangement LBC system may have a radius R1 of approximately 4 centimeters (cm), or in the range of approximately 2 cm-10 cm, and a height H1 of approximately 4 cm, or in the range of approximately 2 cm-10 cm. It will be appreciated that the radius R1 and the height H1 are highly variable, depending upon the type of vehicle and the communication system desired. In this embodiment, two LEDs (and corresponding photodiodes) are mounted in a staggered positioning to illustrate the capacity for aiming the LEDs in a uniformly distributed manner across 180-degrees of the horizontal plane. It will be understood that any other compact arrangement of LEDs (and corresponding photodiodes) may be used if sufficient for satisfactory orientation of the array of optical beam patterns which may include asymmetric lens designs.

FIG. 14 illustrates a top perspective view of optical transmitter elements horizontally aligned so that they project at slightly different angles. Refer, for example, to FIG. 13 showing the LEDs being offset (for example, 1320 and 1324) so that they project at slightly different angles. Other structures may be implemented to achieve techniques of the present disclosures.

Numerous variations and configurations will be apparent in light of the disclosure. For example, one example embodiment of the present disclosure provides a light based communication (LBC) system including a first receiver deployable on a first vehicle, the first receiver configured to receive a first digital message from a first transmitter deployable on a second vehicle, the first digital message identifying a first overlap region of the first transmitter with respect to a second transmitter deployable on the second vehicle and receive a second digital message from the second transmitter, and a processor coupled to the first receiver, the processor configured to determine an angle of the first transmitter with respect to a reference point on the second vehicle based on the first digital message, the second digital message, and the first overlap region identified in the first digital message.

In some embodiments, the reference point on the second vehicle is a 0-degree normal of the second vehicle, and the first digital message further includes position information identifying a first location of the first transmitter with respect to the 0-degree normal of the second vehicle. In some embodiments, the first digital message further identifies an offset angle between adjacent transmitter channels and a coarse outline of the second vehicle. In some embodiments, the first overlap region is provided as a look-up table of ratios indexed by angles of transmittance, in which each angle of transmittance corresponds to a unique ratio of a first intensity of the first transmitter with respect to a second intensity of the second transmitter. In some embodiments, each ratio is of a first signal amplitude of the first transmitter divided by a second signal amplitude of the second transmitter. In some embodiments, the first digital message further identifies a third overlap region of a third transmitter deployable on the second vehicle with respect to the first transmitter and the second transmitter. In some embodiments, the first transmitter is configured to transmit the first digital message at a first predefined time period, and the second transmitter is configured to transmit the second digital message at a second predefined time period that is different from the first predefined time period. In some embodiments, the first predefined time period is identified in the first digital message, and the second predefined time period is identified in the second digital message. In some embodiments, the first transmitter and the second transmitter are deployable on a base that is curved or cylindrical such that a surface normal of the first transmitter is offset at a predefined angle with respect to a surface normal of the second transmitter. In some embodiments, the system further includes a second receiver on the first vehicle that is configured to receive the first digital message from the first transmitter on the second vehicle, and the processor is further coupled to the second receiver and is further configured to determine an angle of the first receiver with respect to a reference point on the first vehicle based on a first intensity of the first digital message received at the first receiver, a second intensity of the first digital message received at the second receiver, and a second overlap region of the first receiver with respect to the second receiver.

Another example embodiment of the present disclosure provides a light based communication (LBC) system including a first receiver on a first vehicle that is configured to receive a first digital message from a first transmitter on a second vehicle, a second receiver on the first vehicle that is configured to receive the first digital message from the first transmitter on the second vehicle, and a processor coupled to the first receiver, the processor configured to determine an angle of the first receiver with respect to a reference point on the first vehicle based on a first intensity of the first digital message received at the first receiver, a second intensity of the first digital message received at the second receiver, and a first overlap region of the first receiver with respect to the second receiver.

In some embodiments, the first digital message includes information identifying a location of the first transmitter. In some embodiments, the first overlap region is stored in a memory of the first vehicle. In some embodiments, the first receiver and the second receiver are on a base that defines a cylindrical post, such that a surface normal of the first receiver is offset at a predefined angle with respect to a surface normal of the second receiver. In some embodiments, the first receiver and the second receiver are on a substrate having a curved shape such that a surface normal of the first receiver is offset at a predefined angle with respect to a surface normal of the second receiver. In some embodiments, the first receiver is further configured to receive a second digital message from a second transmitter deployable on the second vehicle, the first digital message further identifies a second overlap region of the first transmitter with respect to the second transmitter, and the processor is further configured to determine an angle of the first transmitter with respect to a reference point on the second vehicle based on the first digital message, the second digital message, and the second overlap region identified in the first digital message.

Another example embodiment of the present disclosure provides a method including receiving, at a first receiver deployable on a first vehicle, a first digital message transmitted by a first transmitter deployable on a second vehicle, the first digital message identifying a first overlap region with respect to at least a second transmitter deployable on the second vehicle, receiving, at the first receiver, a second digital message transmitted by the second transmitter, and determining, by a processor coupled to the first receiver of the first vehicle, an angle of the first transmitter with respect to a reference point on the second vehicle using the first digital message, the second digital message, and the first overlap region identified in the first digital message.

In some embodiments, the method further includes receiving, at a second receiver on the first vehicle, the first digital message transmitted by the first transmitter on the second vehicle, and determining, by the processor, an angle of the first receiver with respect to a reference point on the first vehicle based on a first intensity of the first digital message received at the first receiver, a second intensity of the first digital message received at the second receiver, and a second overlap region of the first receiver with respect to the second receiver. In some embodiments, the method further includes receiving, at the first receiver of the first vehicle, a third digital message transmitted by a third transmitter of the second vehicle, the third digital message identifying a third overlap region with respect to both the second transmitter and the first transmitter on the first vehicle. In some embodiments, the method further includes receiving, at a second receiver on the first vehicle, the third digital message from the third transmitter on the second vehicle, and determining, by the processor, an angle of the third transmitter with respect to the reference point on the second vehicle using at least one of the first digital message, the second digital message, the third digital message, and the third overlap region identified in the third digital message.

The foregoing description of the embodiments of the disclosure has been presented for the purposes of illustration and description. It is not intended to be exhaustive or to limit the disclosure to the precise form disclosed. Many modifications and variations are possible in light of this disclosure. It is intended that the scope of the disclosure be limited not by this detailed description, but rather by the claims appended hereto.

What is claimed is:

1. A light based communication (LBC) system comprising:
a first receiver deployable on a first vehicle, the first receiver configured to:
receive a first digital message from a first transmitter deployable on a second vehicle, the first digital message identifying a first overlap region of the first transmitter with respect to a second transmitter deployable on the second vehicle; and
receive a second digital message from the second transmitter; and
a processor coupled to the first receiver, the processor configured to determine an angle of the first transmitter with respect to a reference point on the second vehicle based on the first digital message, the second digital message, and the first overlap region identified in the first digital message.

2. The LBC system of claim 1, wherein the reference point on the second vehicle is a 0-degree normal of the second vehicle, and the first digital message further includes position information identifying a first location of the first transmitter with respect to the 0-degree normal of the second vehicle.

3. The LBC system of claim 1, wherein the first digital message further identifies an offset angle between adjacent transmitter channels and a coarse outline of the second vehicle.

4. The LBC system of claim 1, wherein the first overlap region is provided as a look-up table of ratios indexed by angles of transmittance, in which each angle of transmittance corresponds to a unique ratio of a first intensity of the first transmitter with respect to a second intensity of the second transmitter.

5. The LBC system of claim 4, wherein each ratio is of a first signal amplitude of the first transmitter divided by a second signal amplitude of the second transmitter.

6. The LBC system of claim 1, wherein the first digital message further identifies a third overlap region of a third transmitter deployable on the second vehicle with respect to the first transmitter and the second transmitter.

7. The LBC system of claim 1, wherein the first transmitter is configured to transmit the first digital message at a first predefined time period, and the second transmitter is configured to transmit the second digital message at a second predefined time period that is different from the first predefined time period.

8. The LBC system of claim 7, wherein the first predefined time period is identified in the first digital message, and the second predefined time period is identified in the second digital message.

9. The LBC system of claim 1, wherein the first transmitter and the second transmitter are deployable on a base that is curved or cylindrical such that a surface normal of the first transmitter is offset at a predefined angle with respect to a surface normal of the second transmitter.

10. The LBC system of claim 1, further comprising:
a second receiver on the first vehicle that is configured to receive the first digital message from the first transmitter on the second vehicle;
wherein the processor is further coupled to the second receiver and is further configured to determine an angle of the first receiver with respect to a reference point on the first vehicle based on a first intensity of the first digital message received at the first receiver, a second intensity of the first digital message received at the second receiver, and a second overlap region of the first receiver with respect to the second receiver.

11. A light based communication (LBC) system comprising:
a first receiver on a first vehicle that is configured to receive a first digital message from a first transmitter on a second vehicle;
a second receiver on the first vehicle that is configured to receive the first digital message from the first transmitter on the second vehicle; and
a processor coupled to the first receiver, the processor configured to determine an angle of the first receiver with respect to a reference point on the first vehicle based on a first intensity of the first digital message received at the first receiver, a second intensity of the first digital message received at the second receiver, and a first overlap region of the first receiver with respect to the second receiver.

12. The LBC system of claim 11, wherein the first digital message includes information identifying a location of the first transmitter.

13. The LBC system of claim 11, wherein the first overlap region is stored in a memory of the first vehicle.

14. The LBC system of claim 11, wherein the first receiver and the second receiver are on a base that defines a cylindrical post, such that a surface normal of the first receiver is offset at a predefined angle with respect to a surface normal of the second receiver.

15. The LBC system of claim 11, wherein the first receiver and the second receiver are on a substrate having a curved shape such that a surface normal of the first receiver is offset at a predefined angle with respect to a surface normal of the second receiver.

16. The LBC system of claim 11, wherein:
the first receiver is further configured to receive a second digital message from a second transmitter deployable on the second vehicle;
the first digital message further identifies a second overlap region of the first transmitter with respect to the second transmitter; and
the processor is further configured to determine an angle of the first transmitter with respect to a reference point on the second vehicle based on the first digital message, the second digital message, and the second overlap region identified in the first digital message.

17. A method comprising:
receiving, at a first receiver deployable on a first vehicle, a first digital message transmitted by a first transmitter deployable on a second vehicle, the first digital message identifying a first overlap region with respect to at least a second transmitter deployable on the second vehicle;
receiving, at the first receiver, a second digital message transmitted by the second transmitter; and
determining, by a processor coupled to the first receiver of the first vehicle, an angle of the first transmitter with respect to a reference point on the second vehicle using the first digital message, the second digital message, and the first overlap region identified in the first digital message.

18. The method of claim 17, further comprising:
receiving, at a second receiver on the first vehicle, the first digital message transmitted by the first transmitter on the second vehicle; and
determining, by the processor, an angle of the first receiver with respect to a reference point on the first vehicle based on a first intensity of the first digital message received at the first receiver, a second intensity of the first digital message received at the second receiver, and a second overlap region of the first receiver with respect to the second receiver.

19. The method of claim 17, further comprising:
receiving, at the first receiver of the first vehicle, a third digital message transmitted by a third transmitter of the second vehicle, the third digital message identifying a third overlap region with respect to both the second transmitter and the first transmitter on the first vehicle.

20. The method of claim 19, further comprising:
receiving, at a second receiver on the first vehicle, the third digital message from the third transmitter on the second vehicle; and
determining, by the processor, an angle of the third transmitter with respect to the reference point on the second vehicle using at least one of the first digital message, the second digital message, the third digital message, and the third overlap region identified in the third digital message.
